(19) United States
(12) Patent Application Publication
(10) Pub. No.: US 2007/0200498 A1
(43) Pub. Date: Aug. 30, 2007

(54) PLASMA DISPLAY PANEL

(75) Inventors: Kyung Wha LEE, Seoul (KR); Kwang Yeol CHOI, Seongnam-si, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/679,221

(22) Filed: Feb. 27, 2007

(30) Foreign Application Priority Data
Feb. 27, 2006 (KR) 10-2006-0018953

(51) Int. Cl. H01J 17/49

(52) U.S. Cl. 313/582; 313/586; 313/584

(57) ABSTRACT

A plasma display panel is disclosed which is manufactured by filling a main discharge gas formed of a mixture of Ne and Xe added by a gas including an element having an electron affinity of 3 eV or more, whereby a great likelihood of an erroneous discharge caused by discharged particles such as electrons leaking into neighboring cells following a strong sustain discharge is reduced to thereby enable to obtain a high quality PDP.

### CROSS-REFERENCE TO RELATED APPLICATION

This application is based upon and claims the benefit of priority from the prior Korean Patent Application No. 10-2006-0018953, filed on Feb. 27, 2006, the entire contents of which are incorporated herein by reference.

### BACKGROUND

This description relates to a plasma display panel (hereinafter simply referred to as PDP), and more particularly to a PDP where the PDP may include opposing upper plate and lower plate, each plate partitioned by barrier ribs to form a space therebetween, where a main discharge gas may be hermetically filled in the space formed by the barrier ribs, and where the discharge gas may be formed of a mixture of Ne and Xe added by a gas including an element having an electron affinity of 3 eV or more. Typically, the PDP is a flat display device manufactured in such a manner that a discharge gas is filled in two substrates formed with a plurality of electrodes and then hermetically sealed to which a discharge voltage is applied, where an appropriate pulse voltage is applied when the gas produces rays between two electrodes and the pulse voltage is addressed to a point where the two electrodes crisscross to realize the displaying of desired color images such as numbers, characters and graphics. In other words, the PDP is a flat panel display that uses plasma generated by electric discharge in a gas to display characters or images.

The PDP has lately attracted considerable attention in flat display fields due to its simple fabrication method of a super wide screen, an excellent wide viewing angle and a high quality self emissive display capability. The PDP has a wide industrial use as a super thin display for, such as, but not limited to, an advertising pillar tower on a penthouse, a wall-hung TV for home use and a theater display. Additionally, the PDP is further highlighted by characteristics of remarkably reduced weight and thickness due to capability of being manufactured with a thickness of less than 10 cm (centimeters).

PDPs are generally divided into alternating current (AC) and direct current (DC) types according to electrodes being directly or indirectly exposed to dielectric layers. The DC type PDP has electrodes indirectly exposed to a discharge space via the dielectric layers. The difference results in generation of a difference in the discharge phenomenon, and charged particles formed by the discharge in the AC type PDP accumulate at dielectric layers. In other words, the charged particles accumulate at dielectric layers on electrodes applied with positive potentials, and ions accumulate at dielectric layers on electrodes of negative potentials. Among the two types of PDPs, an AC type PDP is most widely used.

In more detailed explanation of the AC type PDPs, each sustain electrode is separated from discharge layers by dielectric layers and protective layers to allow the electrodes not to absorb discharged particles generated during the discharge phenomenon but to form wall charges, such that subsequent discharges are generated using the wall charges.

The schematic structure of the conventional AC type PDP by way of cross-sectional view will be described below with reference to FIG. 1. As illustrated, a conventional PDP is provided with an upper plate and a lower plate, each of transparent substrates, and each plate being interposed by barrier ribs, and discharge cells formed by the barrier ribs are hermetically sealed with discharge gas.

To be further specified, an upper plate (1) and a lower plate (5) oppositely coupled in parallel to the upper plate (1) are arranged in the PDP, each distanced at a predetermined interval. The upper plate (1) is formed in parallel with a plurality of discharge sustain electrodes (2), on which a dielectric layer (3) and a protective layer (4) are coated. The lower plate (5) is formed with a plurality of address electrodes (6), each perpendicular to the discharge sustain electrodes (2) of the upper plate (1), on which a dielectric layer (7) and a phosphor layer (8) formed with an ultraviolet excitation phosphor for illuminating phosphors for red, green and blue rays are coated.

Furthermore, barrier ribs (9) may be perpendicularly formed between the upper plate (1) and the lower plate (5) to prevent optical and electrical cross-talk between adjacent discharge cells and to support the upper and lower plates (1, 5). The cells surrounded by the upper and lower plates (1, 5) and the barrier ribs (9), which are discharge spaces, may be hermetically sealed with discharge gas. The sealing discharge gas generally includes a mixture of Ne and Xe.

In realizing images on the PDPs, a discharge starting voltage is applied to electrodes and a plasma discharge is generated on a protective film. The size of the applied voltage is determined by a gap of inner space formed between the upper and lower plates, kind and pressure of discharge gas filled inside the inner space, and nature of dielectric substance and protective film. Positive ions and electrons in the inner space during the plasma discharge move with mutually opposite polarizations, such that surface of the protective film is divided into two portions each having an opposite polarization. The wall charges stay on the surface of the protective film as the protective film is intrinsically an insulating material having a high resistance. The AC type PDP thus has a structure of intrinsic memory function, i.e., a phenomenon where a discharge is sustained at a voltage lower than the discharge starting voltage due to influence of the wall charges. To be more specific, display discharges continue relative to the cells selected after an address discharge between an address electrode of the lower plate and a discharge sustain electrode of the upper plate, where vacuum ultraviolet rays generated in the course of discharge gas excitation excite a phosphor to emit visible light to form desired image on the PDP.

However, the conventionally-structured AC type PDP suffers from a disadvantage in that discharged particles such as electrons leak into neighboring cells through gaps between barrier ribs and an upper panel following a strong sustain discharge to sometimes generate an unwanted illumination. The unwanted erroneous discharge leads to a reduction in characteristics of the PDPs and occurrence of inferior quality products. It is therefore imperative to address this problem.

### SUMMARY

The present disclosure is presented to overcome the above-mentioned problems. An object is to provide a plasma display panel (hereinafter simply referred to as PDP), the PDP manufactured by filling a main discharge gas formed of a mixture of Ne and Xe added by a gas including an element having an electron affinity of 3 eV or more, whereby a great likelihood of an erroneous discharge caused by discharged particles such as electrons leaking into neighboring cells following a strong sustain discharge is reduced to thereby enable to obtain a high quality PDP.

In one general aspect, the PDP comprises: an upper plate formed to include a plurality of discharge sustain electrodes and a dielectric layer covering the discharge sustain electrodes; a lower plate formed to include a plurality of address electrodes and a dielectric layer covering the address electrodes; barrier ribs partitioning discharge spaces between the upper plate and the lower plate; a phosphorous material coated on the lower plate and the barrier ribs; and a discharge gas hermetically sealed in the discharge spaces, wherein the discharge gas is formed of a mixture of Ne and Xe added by a gas including an element having an electron affinity of 3 eV or more.

### BRIEF DESCRIPTION OF THE DRAWINGS

FIG. 1 is a schematic structure of the conventional PDP by way of cross-sectional view.

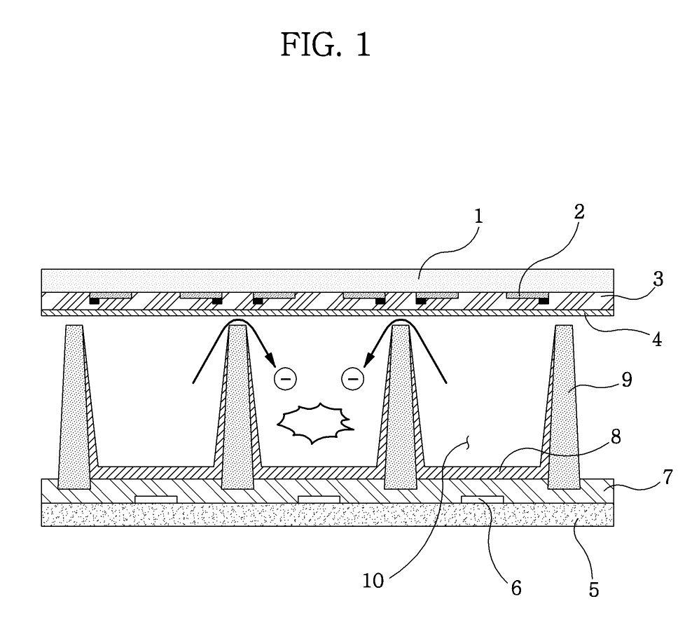

FIG. 2 is a schematic cross-sectional view of a PDP according to an exemplary embodiment of the present disclosure.

### DETAILED DESCRIPTION

The present description is disclosed more fully hereinafter with reference to the accompanying drawings, in which embodiments of the disclosure are shown. This disclosure may, however, be embodied in many different forms and should not be construed as limited to the embodiments set forth herein. Thus, the description is not intended to limit the scope of the present disclosure.

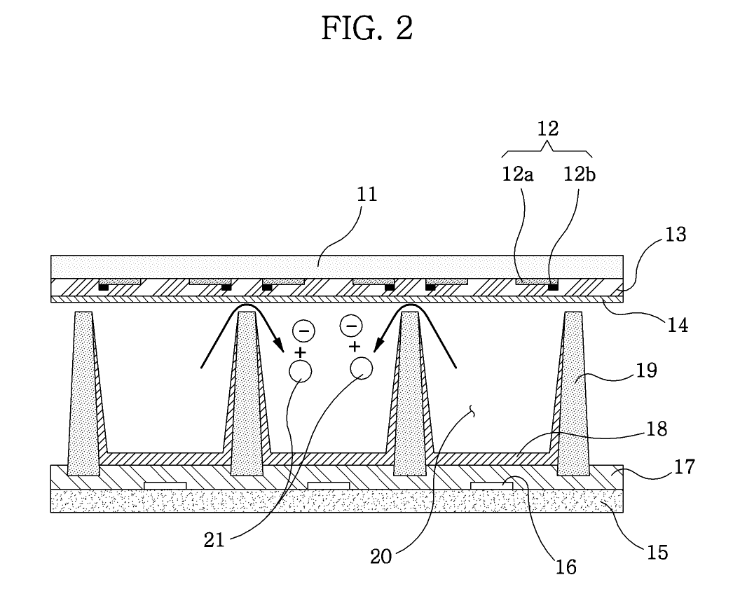

FIG. 2 is a schematic cross-sectional view of a PDP according to an exemplary embodiment of the present disclosure, where an upper plate (11) and a lower plate (15) are oppositely arranged, each plate distanced at a predetermined space apart.

The upper plate (11) is formed in parallel with a plurality of equidistant discharge sustain electrodes (12), and the discharge sustain electrodes are coated with a Pb-based dielectric layer (13) for generation of wall discharges. The coated dielectric layer (13) is further formed with a protective layer (14) such as a MgO film having a high secondary electron emission coefficient. As depicted in FIG. 2, the discharge sustain electrode (12) is comprised of a transparent electrode (12a) and a bus electrode of metal with a narrow line width. The transparent electrode is employed for light transmission, while the bus electrode is used in the form of coupling with the transparent electrode for compensation of high resistance of the transparent electrode.

Meanwhile, the lower plate (15) is formed with a plurality of address electrodes (16), and the address electrodes (16) are coated with a dielectric layer (17) for generation of wall charges. The coated dielectric layer (17) is further formed with a phosphor (18) comprised of ultraviolet excited red, green and blue phosphorous materials to form the desired image on the coated dielectric layer (17). At this time, each cell is arranged with one color of phosphor.

Furthermore, barrier ribs (19) are arranged between the upper plate (11) and the lower plate (15) covered with the dielectric layer (17) in a predetermined pattern such as stripes or closed-type rectangular matrices. The barrier ribs (19) are perpendicularly formed between the upper plate (11) and the lower plate (15) to sustain a discharge distance, to prevent optical and electrical cross-talk between adjacent discharge cells and to support the upper and lower plates (11, 15). The discharge sustain electrode (12) and the address electrode (16) formed on the upper plate (11) and the lower plate (15) are orthogonally arranged to each other, where one discharge cell is arranged with a pair of discharge sustain electrodes (12). The cells surrounded by the upper plate (11), the lower plate (15) and the barrier ribs (19) are hermetic discharge spaces (20) in which discharge gas is filled. The main discharge gas of the PDP is composed of a Penning mixture gas, such as chemically stable inert gases of Ne—Xe. The inert gases are excited during discharges to generate ultraviolet rays. The ultraviolet rays collide with the phosphor surrounding periphery of the address electrodes and barrier ribs to excite the phosphor, and the excited phosphor generates visible light, thereby forming desired images on the PDP. The reason why the mixture of Ne and Xe is used a buffer gas is that an electron temperature in the mixture is higher than that of a pure Xe gas, a voltage-decreasing effect caused by a Penning effect due to Xe, and a sputtering effect caused by a high pressure can be reduced.

The Penning effect is such that, in a case that a gas in a semi-stable state is mixed with a small quantity of another kind of gas, a discharge starting voltage decreases when an ionization potential of the mixed gas is lower than the semi-stable excitation voltage of the original gas, and ultraviolet rays can be easily generated during discharges by the Penning effect. For example, the Penning effect of Ne+Xe can be summarized as below.
Ne*+Xe→Xe⁺+e+Ne
where, Ne is a main gas, Xe is an added gas which is appropriate when less than 5%, and Ne are particles of semi-stable state.

However, there are formed gaps between the barrier ribs and the upper plate, through which charged particles excessively coming out during strong sustain discharges leak into neighboring cells. In this case, an unwanted illumination may occur due to charged particles that have moved to adjacent cells. Particularly, a great likelihood of an erroneous discharge may occur due to electrons having a high mobility leaking to neighboring cells. Accordingly, a main gas is added with other gases including an element having an electron affinity of 3 eV or more. In other words, other kinds of gases including an element having a strong electron affinity are coupled with overflow electrons causing an erroneous discharge to prevent the overflow electrons from exciting Xe, thereby enabling to effectively control the likelihood of occurrence of erroneous discharge. Therefore, a gas containing an element having a strong electron affinity can easily be coupled with overflow electrons and becomes a negative ion.

It is more preferable to add a gas containing an element having an electron affinity of 3.2 eV or more. If a gas containing an element having an electron affinity of 3.2 eV or more is added, the erroneous discharge can be more effectively prevented. Examples of the above gases having an electron affinity of 3 eV or more include Cl, F, Br and I, respectively having an electron affinity of 3.61 eV, 3,45 eV, 3.36 eV and 3.06 eV.

In the PDP of FIG. 2, a discharge space (20) confined by a barrier rib (19) is hermetically sealed by a main discharge gas which is a mixture of Ne and Xe, plus a gas (21) containing an element having an electron affinity of 3 eV or more. Here, the ‘gas’ includes not only the one that can exist at room temperature in gaseous state under one atmospheric pressure but also the one that can be gasified and exist in a gaseous state in a condition of being injected into a hermetic discharge space of the PDP and discharged.

As an example of gas that contains an element having an electron affinity of 3 eV or more, it is preferable to choose at least one member selected from a group composed of gases satisfying the following Formula 1.
CₙXₐH_{b} <Formula 1>
(where, n is an integer of 0˜3, a is an integer of 1˜8, b is an integer of 0˜7, and a+b=2n+2, and where, X is selected from a group composed of F, Cl, Br and I, and when two or more are selected, these may be identical or different.)

Preferably, but not limited, the gas includes the one containing an element that is selected from a group of F, Cl and Br having an electron affinity of 3 eV or more. More detailed example of gases that contain an element having an electron affinity of 3 eV or more includes I₂, Br₂, Cl₂, IBr, CH₃Br, CH₂Br₂ and CH₂Cl₂, and among them, one of Br₂, C1₂, CH₃Br, CH₂Br₂ and CH₂Cl₂ may be preferably selected. The concentration of other kinds of gases that are injected into the discharge space of the PDP is not particularly limited, but, it is preferred that the gas containing an element having an electron affinity of 3 eV or more is 1% and less in tension thereof relative to a pressure of a total injected gas. It is more preferably to be 0.05% or more but 1% and less in tension thereof relative to a pressure of a total injected gas.

If concentration of another kind of added gas is 0.01% and less, the likelihood of occurrence of erroneous discharge may be minuscule. Furthermore, a discharge efficiency is preferably optimum when contents of Xe is 4˜20%, and more preferably, 10˜15% in tension thereof in the main discharge gas ratio between Xe and Ne, and if another kind of gas having contents exceeding 1% is injected, released vacuum ultraviolet rays may decrease and be susceptible to a degradation in the discharge efficiency.

As apparent from the foregoing, there is an advantage in the Plasma Display Panel (PDP) thus described according to the present disclosure in that a main discharge gas added by a gas containing an element having a strong electron affinity is injected into a discharge space, thereby overcoming the disadvantage of the conventional PDP and providing a high quality of images, whereby a great likelihood of an erroneous discharge caused by discharged particles such as electrons leaking into neighboring cells following a strong sustain discharge can be reduced to thereby enable to obtain a high quality PDP.

As the present disclosure may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A plasma display panel comprising: an upper plate formed to include a plurality of discharge sustain electrodes and a dielectric layer covering the discharge sustain electrodes; a lower plate formed to include a plurality of address electrodes and a dielectric layer covering the address electrodes; barrier ribs partitioning discharge spaces between the upper plate and the lower plate; a phosphorous material coated on the lower plate and the barrier ribs; and a discharge gas hermetically sealed in the discharge spaces, wherein the discharge gas is formed of a mixture of Ne and Xe added by a gas including an element having an electron affinity of 3 eV or more.

2. The plasma display panel as claimed in claim 1, wherein at least one gas including an element having an electron affinity of 3 eV or more is chosen from a group composed of gases satisfying the following Formula 1.
CₙXₐH_{b} <Formula 1>
where, n is an integer of 0˜3, a is an integer of 1˜8, b is an integer of 0˜7, and a+b=2n+2, and where, X is selected from a group composed of F, Cl, Br and I, and when two or more are selected, these are identical or different.

3. The plasma display panel as claimed in claim 1, wherein the gas including an element having an electron affinity of 3 eV or more includes at least one of the gases of Cl, F, Br and I.

4. The plasma display panel as claimed in claim 1, wherein one or more gases that contain an element having an electron affinity of 3 eV or more are selected from a group composed of I₂, Br₂, Cl₂, IBr, CH₃Br, CH₂Br₂ and CH₂Cl₂.

5. The plasma display panel as claimed in claim 1, wherein the gas including an element having an electron affinity of 3 eV or more is 0.05% or more but 1% and less in tension thereof relative to pressure of a total injected gas.

6. The plasma display panel as claimed in claim 1, wherein the gas including an element having an electron affinity of 3 eV or more is a gas including an element having an electron affinity of 3.2 eV.

7. The plasma display panel as claimed in claim 1, wherein contents of Xe in the discharge gas is 4˜20% in tension thereof relative to a total pressure of the discharge gas.

8. The plasma display panel as claimed in claim 1, wherein the contents of Xe in the discharge gas is 10˜15% in tension thereof relative to a total pressure of the discharge gas.
